(19) United States
(12) Patent Application Publication
(10) Pub. No.: US 2013/0085891 A1
(43) Pub. Date: Apr. 4, 2013

(54) METHOD FOR FACILITATING PURCHASE OF VARIABLE PRICED ITEMS AND RELATED APPARATUS

(71) Applicants: Daniel Barber, Tustin, CA (US); Philip Defay Wu, Seal Beach, CA (US)

(72) Inventors: Daniel Barber, Tustin, CA (US); Philip Defay Wu, Seal Beach, CA (US)

(73) Assignee: KONICA MINOLTA LABORATORY U.S.A., INC., San Mateo, CA (US)

(21) Appl. No.: 13/250,477

(22) Filed: Sep. 30, 2011

(51) Int. Cl. G06Q 30/06

(52) U.S. Cl. 705/26.61; 705/26.8

(57) ABSTRACT

A system is described for facilitating purchase of copyrighted works, in particular, works that may be offered for variable prices depending on the purchaser's characteristics. A server interacts with multiple digital content repositories as well as users. The server stores user characteristics information in user accounts, and uses such information to obtain best prices for users for the contents they request. If additional user characteristics information is request by some repositories before offering a price, the server interacts with the user to obtain such information. The server automatically selects the best price among those offered by the repositories, and completes the purchase transaction.

### BACKGROUND OF THE INVENTION

1. Field of the Invention

This invention relates to a method for facilitating purchase of items such as goods, services, digital contents, etc., in particular, to facilitate such purchases when the items are offered for variable prices depending on the purchasers' characteristics.

2. Description of Related Art

In some retail transactions, the offered price for items may be variable depending on characteristics of the purchaser. For example, the price for copyrighted materials (e.g. digital content) offered by copyright holders may be discounted for some particular group of users. In addition, multiple sources for the same items may exist and be made available to purchasers depending on their characteristics, resulting in purchasers being able to purchase items at different prices depending on their characteristics. For example, an organization may maintain a library of digital materials and make them available to members of the organization for free or for a discounted price, while charging users from outside of the organization higher prices.

### SUMMARY

The present invention is directed to a method and related system and apparatus for facilitating purchase of items that are available to purchasers at variable prices depending on characteristics of the purchasers.

An object of the present invention is to provide such a system that is convenient and easy to use for the users.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented on a server for facilitating purchases of variable priced items by a user, which includes: (a) storing user characteristics information for a plurality of users in a plurality of user accounts; (b) transmitting a first price request on behalf of a user to each of a plurality of sources of an item, the price request including a first set of user characteristics information obtained from the user's user account; (c) receiving at least one information request for additional user characteristics information from at least one of the plurality of sources; (d) based on all of the at least one information request received from the at least one sources in step (c), dynamically generating a request to the user for additional user characteristics, and transmitting the request to a client for display to the user; (e) receiving additional user characteristics information from the client in response to the request transmitted in step (d); (f) transmitting a second price request to each of the at least one of the plurality of sources from which an information request is received in step (c), the second price request including a second set of user characteristics information responsive to the information request received in step (c); (g) receiving offered prices from the plurality of sources in response to the first price request or the second price request, at least some of the offered prices being dependent on the first or second set of user characteristics information; (h) selecting one of the plurality of source based on the offered prices; and (i) completing a purchase transaction for the item from the selected source.

In another aspect, the present invention provides a computer program product comprising a computer usable non-transitory medium (e.g. memory or storage device) having a computer readable program code embedded therein for controlling a data processing apparatus such as a computer, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a system in which embodiments of the present invention may be implemented.

FIG. 2 illustrates a method according to an embodiment of the present invention.

### DETAILED DESCRIPTION OF PREFERRED EMBODIMENTS

Embodiments of the present invention provide a system and method for facilitating purchase of items, such as goods, services, digital content, etc., where the items may be available for variable or different prices depending on the characteristics of the purchasers. It should be noted that the term “purchase” is used in this disclosure to refer to relevant transitions regardless of whether they involve a payment of money (e.g. sometimes items may be free of charge). In the following descriptions, a system for facilitating purchase of copyrighted digital content is used as an example, but the invention is not limited thereto.

As digital contents are often protected by copyright, users often need to obtain such contents through a purchase. Currently, copyright clearinghouses exist to facilitate distribution of copyrighted materials and to obtain and transfer payment to copyright holders. An example is Copyright Clearance Center. Still, many publishers of copyrighted work do not participate in a central repository that allows users to view, request, and purchase a right to view or print their works. With print/view on demand systems becoming more common, it is likely that a more centralized system will be developed to perform these functions. Currently, it is often necessary to deal with multiple sources to obtain copyrighted works. Further, many organizations maintain their own library of digital contents, including copyrighted works which the organization have obtained the right to use, and make them available to members of the organizations free of charge. Thus, the users potentially have multiple sources from which to obtain digital contents. Embodiments of the present invention provide an automated method that enables the users to obtain digital contents at best price based on the users' characteristics.

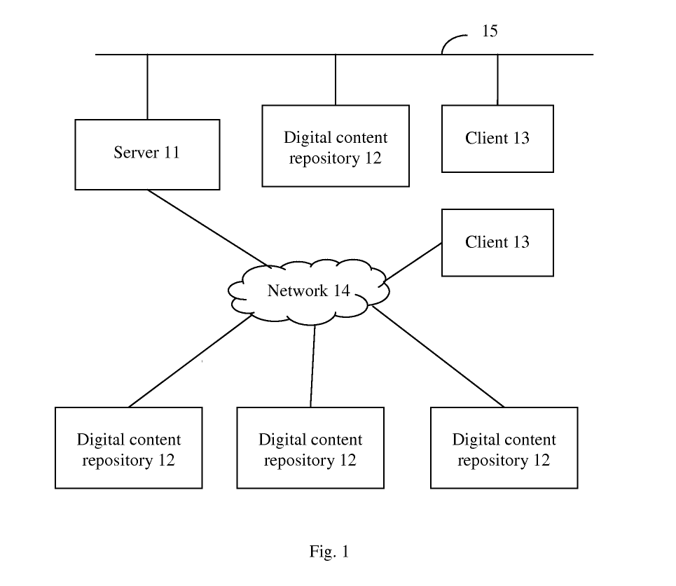

FIG. 1 illustrates a system in which embodiments of the present invention may be implemented. The system 10 includes a server 11 connected to one or more repositories of digital contents 12 via a public network 14 such as the internet or a private network 15 such as an intranet of an organization. The repositories 12 may be servers maintained by publishers, clearing houses for copyrighted works, libraries, or the like. Users may access the server 11 from client computers 13, which may be connected to the server 11 via the public network 14 or the private network 15. Typically, the digital content repositories 12 and the server 11 are operated by different entities, and the repositories may be referred to as third party repositories. The server 11 acts as an intermediary between the repositories 12 and the clients 13 and performs various functions as will be described later. The server 11 is a computer system that includes relevant hardware such as processors, memories, storage devices, etc., where application programs are stored in the memories or storage devices and executed by the processors to carry out the server's functions.

The server 11 provides a user interface to allow a user at clients 13 to search for, obtain prices for, purchase, view and/or print copyrighted works from the repositories 12. In a preferred embodiment, the server 11 is operated by a print shop, and the search and purchase of content may be a part of an overall print-on-demand (POD) process that produces a printed product containing the purchased works, such as a booklet.

The server 11 maintains user accounts of users registered on the server. The user accounts typically store certain information about the user, such as their occupation or status, their membership in various organizations, names, emails, unique identification numbers, etc.

The server 11 interacts with the repositories to facilitate transactions involving copyrighted works. The server 11 is specifically designed to communicate with the repositories 12 and is able to fulfill various information requests by the repositories. Because multiple repositories 12 may exist from which a particular work may be available, the server 11 communicates with multiple repositories to conduct searches, and provides the result back to the user. Thus, the users only need to interact with the server 11 in a streamlined process without having to separately deal with multiple repositories 12.

One important aspect of the system and method according to embodiments of the present invention is that, when one or more repositories 12 have variable pricing policies that provide different pricing to different users based on their user characteristics, the server 11 communicates with the repositories as well as the client 13 to automatically provide the required user characteristics information to the repositories to obtain the best pricing for the user. The user characteristic information may include, for example, the user's occupation or status, membership in organizations, names, emails, unique identification number, etc. The server 11 stores certain information regarding the users in the user accounts, and can automatically transmit such information to the repositories when required. The server 11 can also interact with the user to obtain additional information about user characteristics if needed.

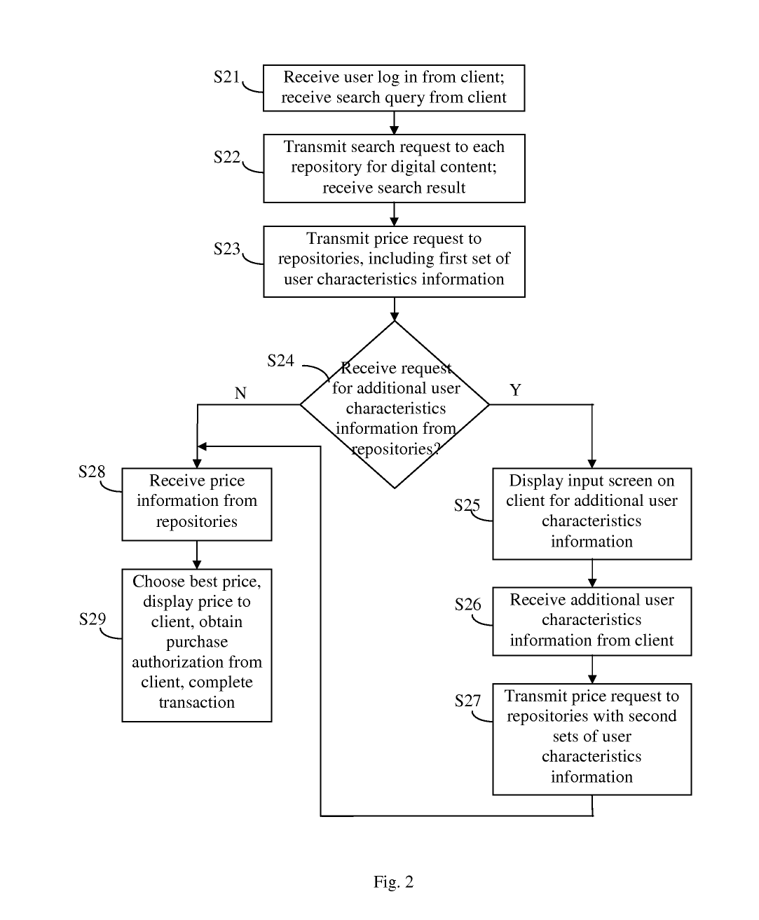

A method implemented on the server 11 is described with reference to FIG. 2. As shown in FIG. 2, first, the server receives a user log in, and receives a search query from the user to search for digital content (step S21). In the log in process, the user may directly log in to the server, or he may be directed from a portal system. The server preferably uses a GUI (graphical user interface) to facilitate the interaction with the user. The GUI is designed to allow the user to search by title, author, keyword, classification, index, and/or other metadata.

Then, the server 11 transmits a search request to each of the multiple repositories 12 for the digital content, and receives a search result from each repository (step S22). The search requests are based on the query entered by the user; the server may reformat the query for each repository based on the input format of the repositories. Note that step S22 may be interactive, e.g., a list of hits may be received from each repository 12, a list of hits may be displayed on the client 13, and a user selection may be received from the client. In addition, the repositories 12 may return certain data (such as abstracts) for items in the hit list, which may be transmitted to the client 13 to assist the user in selecting the content.

When the digital content is found, the server requests a price from each repository that offers the content (step S23). In this step, the server transmits to the repository a first set of user characteristics information regarding the user, using user information stored in the user account. In response, each repository may either reply with a price for the content which is specific to the user, if the first set of user characteristics information transmitted in step S23 contains sufficient information for that repository; or it may reply with a request for additional user characteristics information before offering a price.

If the server receives a request for additional user characteristics information from some of the repositories (“Y” in step S24), it generates and displays an input screen on the client for the user to enter additional user characteristics information (step S25). The display is generated dynamically based on what additional information is requested by the repositories. While different repositories may request different additional information, the display is designed to obtain all such requested information from the user at once. After receiving the additional user characteristics information from the client (step S26), the server transmits a price request with a second set of user characteristics information to each requesting repository (step S27). The second sets of user characteristics information is responsive to the request received in step S24, i.e., the second sets of user characteristics information may be different for different repositories depending what was requested.

After transmitting the second sets of user characteristics information (in step S27), or after transmitting the original price request (in step S23) if the repositories does not request additional user characteristics information (“N” in step S24), the server receives a price for the content from each repository (step S28). The server automatically selects the repository that offers the best price, displays the price to the user, obtains user authorization for a purchase, and completes the purchase transaction (step S29). This step may include downloading the digital content from the selected repository, obtaining payment from the user, informing the selected repository of the purchase or forwarding payment to the selected repository, etc. As a result, the selected repository is notified of activities with respect to their works, and can properly compensate holders of the copyright.

In one embodiment, the price request transmitted in step S23 further specifies the type of right being sought, and the prices returned by the repositories may depend on the type of right in addition to the user characteristics. This is useful in various practical situations. For example, when a first user assembles a compilation of materials for use by other users, the first user may search for digital contents but only intend to view it for the purpose of assembling the compilation, without downloading or printing a copy. Some repositories may allow such a first user (a user having a predefined status) to view contents free of charge. Later, when another user having a different status requests the same content, the right being sought will be the right to download and/or print a copy, and the price may be different.

In another example, some repositories may have “wholesale” or group purchase prices for contents. When a first user assembles a compilation of materials, the first user may request group purchase price information from the repositories (i.e. the right being sought would be identified as a group purchase for a fixed or minimum number of copies). After obtaining a best group purchase price, a group identifier may be assigned for such a group purchase. Later, when a second user belonging to the group requests a price, the group identifier is transmitted to the repository as a part of the user characteristics information of the second user.

The system described here has many practical advantages. It enables users to easily search for copyrighted works that third party repositories may contain. This will make it easy for users to find, obtain, and properly use the works in the third party repository. The system is able to find information, such as prices, about specific copyrighted works and communicate this information to a user without extra effort on the part of the user. This will ensure that a greater number of users choose to use the system to properly obtain copyrighted work while at the same time ensuring the holders of the copyrights are compensated. Because the system will obtain rights for a user for works that they choose to purchase, the system can charge these users appropriately during a checkout process. Users are able to see and pay for these rights up-front, and the system can communicate user actions and payment to the third part rights repository, so it can properly compensate the holders of the copyright. Overall, because the process of properly obtaining rights to use copyrighted work is made easy for users, the system encourages users to use copyrighted works in an appropriate manner which will in turn result in the right holders being properly compensated.

The invention is not limited to the purchase of copyrighted digital contents; it is applicable in other purchase situations where the offered price of an item by various sources of the item are variable depending on characteristics of the purchaser.

It will be apparent to those skilled in the art that various modification and variations can be made in the method and system of the present invention without departing from the spirit or scope of the invention. Thus, it is intended that the present invention cover modifications and variations that come within the scope of the appended claims and their equivalents.

What is claimed is:

1. A method implemented on a server for facilitating purchases of variable priced items by a user, comprising:
(a) storing user characteristics information for a plurality of users in a plurality of user accounts;
(b) transmitting a first price request on behalf of a user to each of a plurality of sources of an item, the price request including a first set of user characteristics information obtained from the user's user account;
(c) receiving at least one information request for additional user characteristics information from at least one of the plurality of sources;
(d) based on all of the at least one information request received from the at least one sources in step (c), dynamically generating a request to the user for additional user characteristics information, and transmitting the request to a client for display to the user;
(e) receiving additional user characteristics information from the client in response to the request transmitted in step (d);
(f) transmitting a second price request to each of the at least one sources from which an information request is received in step (c), the second price request including a second set of user characteristics information responsive to the information request received in step (c);
(g) receiving offered prices from the plurality of sources in response to the first price request or the second price request, at least some of the offered prices being dependent on the first or second set of user characteristics information;
(h) selecting one of the plurality of source based on the offered prices; and
(i) completing a transaction to purchase the item from the selected source.

2. The method of claim 1, wherein the user characteristics information includes one or more of an occupation of the user, an organizational membership of the user, name of the user, email address of the user, and a unique identification of the user.

3. The method of claim 1, wherein the item is a copyrighted digital content.

4. The method of claim 3, further comprising, before step (b), searching for the digital content in the plurality of sources.

5. The method of claim 3, wherein step (i) includes:
downloading the digital content from the selected source;
obtaining payment from the user; and
transmitting informing regarding the purchase to the selected source.

6. The method of claim 3, wherein the first price request specifies a type of right being sought for the digital content, and wherein at least some of the offered prices are dependent on the type of right being sought.

7. The method of claim 6, wherein the user characteristics information includes a group identifier for a group purchase.

8. A computer program product comprising a computer usable non-transitory medium having a computer readable program code embedded therein for controlling a data processing apparatus, the computer readable program code configured to cause the data processing apparatus to execute a process for facilitating purchases of variable priced items by a user, the process comprising:
(a) storing user characteristics information for a plurality of users in a plurality of user accounts;
(b) transmitting a first price request on behalf of a user to each of a plurality of sources of an item, the price request including a first set of user characteristics information obtained from the user's user account;
(c) receiving at least one information request for additional user characteristics information from at least one of the plurality of sources;
(d) based on all of the at least one information request received from the at least one sources in step (c), dynamically generating a request to the user for additional user characteristics information, and transmitting the request to a client for display to the user;
(e) receiving additional user characteristics information from the client in response to the request transmitted in step (d);
(f) transmitting a second price request to each of the at least one sources from which an information request is received in step (c), the second price request including a second set of user characteristics information responsive to the information request received in step (c);
(g) receiving offered prices from the plurality of sources in response to the first price request or the second price request, at least some of the offered prices being dependent on the first or second set of user characteristics information;
(h) selecting one of the plurality of source based on the offered prices; and
(i) completing a transaction to purchase the item from the selected source.

9. The computer program product of claim 8, wherein the user characteristics information includes one or more of an occupation of the user, an organizational membership of the user, name of the user, email address of the user, and a unique identification of the user.

10. The computer program product of claim 8, wherein the item is a copyrighted digital content.

11. The computer program product of claim 10, wherein the process further comprises, before step (b), searching for the digital content in the plurality of sources.

12. The computer program product of claim 10, wherein step (i) includes:
downloading the digital content from the selected source;
obtaining payment from the user; and
transmitting informing regarding the purchase to the selected source.

13. The computer program product of claim 10, wherein the first price request specifies a type of right being sought for the digital content, and wherein at least some of the offered prices are dependent on the type of right being sought.

14. The computer program product of claim 10, wherein the user characteristics information includes a group identifier for a group purchase.
